(19) United States
(12) Patent Application Publication
(10) Pub. No.: US 2003/0047058 A1
(43) Pub. Date: Mar. 13, 2003

(54) Guitar stick and pick

(76) Inventor: Teresa Lynn Pearson-Bey, Sharon Hill, PA (US)

Correspondence Address: Teresa L. Pearson - Bey, 339 Laurel Road, Sharon Hill, PA, 19079, US

(21) Appl. No.: 09/879,938

(22) Filed: Sep. 10, 2001

(51) Int. Cl. G10D 3/16

(52) U.S. Cl. 84/322

(57) ABSTRACT

While observing the professional and amateur guitarist playing their instrument I realized at times they lose their pick or have to reposition the guitar pick while strumming or plucking the strings of their instrument. For that reason I decided to design the guitar stick and pick. When you use the guitar stick and pick you will have complete control of the pick while strumming or plucking the instrument. Since the pick is temporarily mounted on the strip you can position it at any angel to formulate your own particular strumming or plucking style with comfort and confidence while playing.

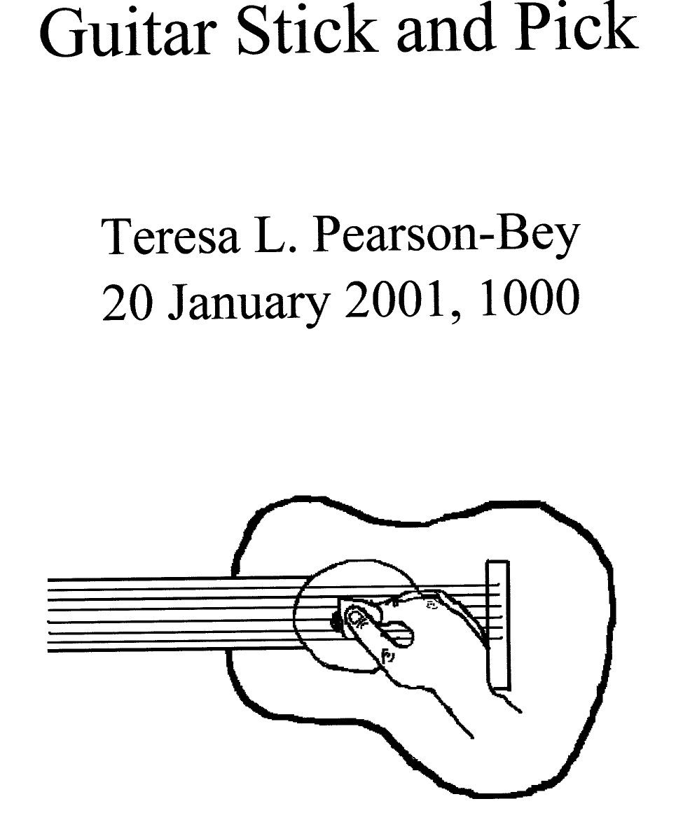

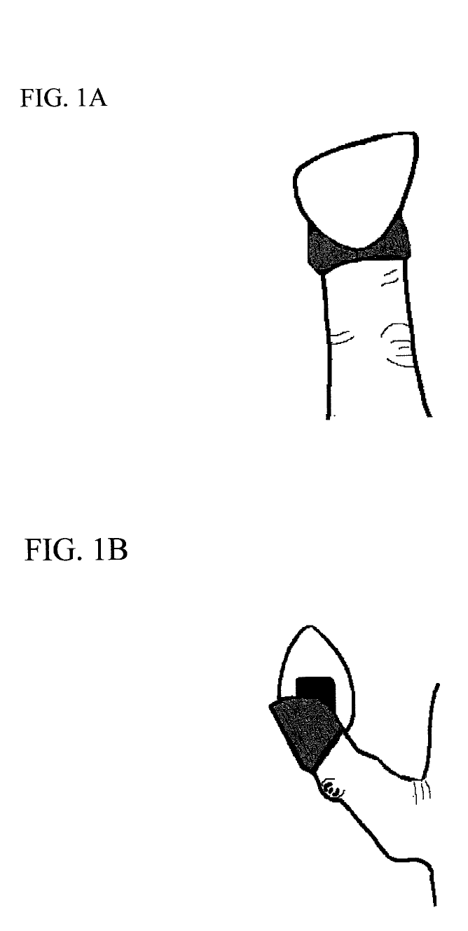

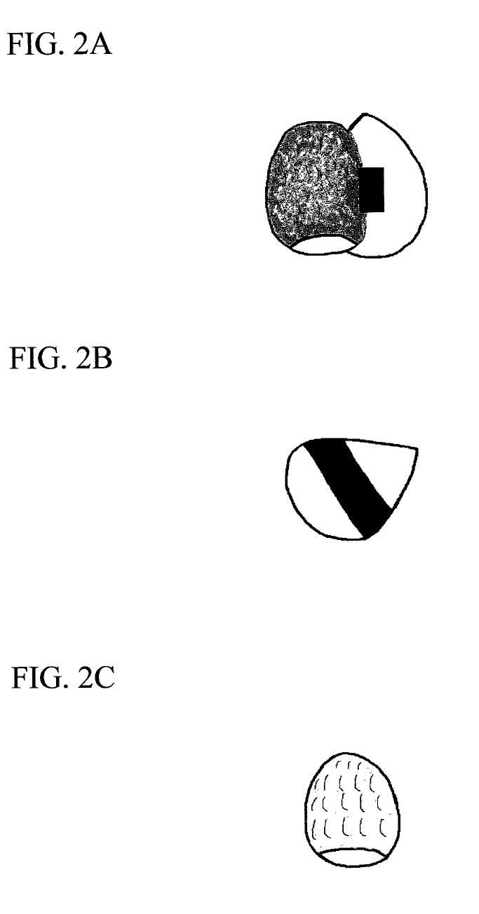

While observing the professional and amateur guitarist playing their instrument I realized at times they lose their pick or have to reposition the guitar pick while strumming or plucking the strings of their instrument. For that reason I decided to design the guitar stick and pick. When you use the guitar stick and pick you will have complete control of the pick while strumming or plucking the instrument. Since the pick is temporarily mounted on the strip you can position it at angel to formulate your own particular strumming or plucking style with comfort and confidence while playing.

### Guitar Stick and Pick

The elastic stick strip with pick attached. Shown on the index finger in an upright position.

The elastic stick strip with pick attached. Shown on the thumb in an upright position.

### Guitar Stick and Pick

This stick strip fit securely on any finger or thumb and is very easy to remove. My guitar pick can be angled in any desired playing position.

Elastic finger stick strip.

The stick strip material allows the guitar pick to remain stationary until manually repositioned.

### Guitar Stick and Pick

The purpose for the Stick and Pick is to allow the guitarist to position the Guitar Stick Strip Pick (above number-1) onto the Finger Stick Strip (above number-2) at any angle as shown in the diagram below.

As a guitarist, this Stick and Pick will allow you to position or reposition the pick in your own unique style. The Stick and Pick can be on any finger or thumb you choose. Amateurs and Professionals. Children and adults can use it with comfort and ease.

### SUMMARY

For all guitarist who desires better control of their plucking or strumming style. They can place the elastic band onto desire finger and attach the guitar stick and pick to the elastic finger band at any playing angle. This will allow complete concentration while playing their music. No longer will you need to focus on loosing or repositioning the pick.

1, Teresa L. Pearson-Bey claim sole and rightful ownership of the invention Guitar Stick and Pick. I hereby declare property rights and maintain there is no other such product on the market domestic or international. I also declare that this invention and use is designed to improve the subjects technique and is designed to be practical and effective in matter and purpose. I hereby maintain that my invention meets all conformities set forth by the United States Patent and Trademark Office.
